(19) United States
(12) Patent Application Publication
(10) Pub. No.: US 2022/0027895 A1
(43) Pub. Date: Jan. 27, 2022

(54) Inter Wallet Transactions

(71) Applicant: Visa International Service Association, San Francisco, CA (US)

(72) Inventors: Yuanbo Zhu, Singapore (SG); Hang Nga Nguyen, Kensington (AU); Zhi Min Ong, Singapore (SG); Linghan Zhang, Singapore (SG); Ying Jie Lim, Singapore (SG); Li Wencheng, Singapore (SG)

(21) Appl. No.: 16/938,026

(22) Filed: Jul. 24, 2020

(51) Int. Cl. G06Q 20/36; G06Q 40/04; G06Q 20/38; G06Q 30/00; G06Q 20/40; G06Q 40/02; G06K 7/14; G06K 7/10; H04L 9/08

(52) U.S. Cl. CPC G06Q 20/3674; G06Q 40/04; G06Q 20/381; G06Q 30/0185; G06Q 20/4016; G06Q 20/34; G06K 7/1413; G06K 7/1417; G06K 7/10297; H04L 9/0861; G06Q 40/02

(57) ABSTRACT

The present disclosure relates to methods and a system for performing inter wallet transactions. The present disclosure provides methods and a system for enabling inter wallet transactions. The system provides an application for enabling inter wallet transactions. A plurality of wallets is registered with the application and a plurality of users associated with one or more of the plurality of wallets is also registered with the application. An intermediate account is created in the application for each user. When a first user associated with a first wallet among the plurality of wallets initiates a transaction to be made to a second user associated with a second wallet among the plurality of wallets, the application debits an amount to the intermediate account in the application and transfers the amount to the second user associated with the second wallet. Therefore, seamless transactions can be made between any wallets registered with the system.

### BACKGROUND

### 1. Technical Field

The present disclosure relates generally to electronic transactions, and more specifically, to methods to enable inter wallet transactions.

### 2. Technical Considerations

Electronic wallet (e-wallet) or digital wallet or mobile wallet transactions are increasing as they provide simpler processes for making transactions. E-wallets have many benefits over conventional transaction techniques including card payments, cash payments, bank transfers, and the like. As electronic devices have evolved immensely, the e-wallets have benefitted the technological advancements. E-wallets are applications installed in electronic devices, and payment from an e-wallet can be made using Bluetooth®, Near Field Communication (NFC), and the like.

Existing e-wallets do not provide an option to transact with other e-wallets, for example, transferring money from one wallet to another wallet. Further, transactions between wallets are a challenge as there does not exist a centralized system to enable the transactions between the wallets. Also, cross-border transactions are even more challenging as wallets do not recognize other wallets easily (especially when codes are scanned). Thus, there is a need to enable transactions between e-wallets.

The information disclosed in this background of the disclosure section is only for enhancement of understanding of the general background of the invention and should not be taken as an acknowledgement or any form of suggestion that this information forms existing art already known to a person skilled in the art.

### SUMMARY

Additional features and advantages are realized through the techniques of the present disclosure. Other embodiments and aspects of the disclosure are described in detail herein and are considered a part of the claimed disclosure.

In some non-limiting embodiments or aspects, provided is a computer-implemented method, comprising: receiving a request from a first user associated with a first wallet server for transferring an amount from the first wallet server to a second wallet server, wherein a second user is associated with the second wallet server, wherein the first wallet server and the second wallet server correspond to a first wallet and a second wallet among a plurality of wallets registered with an inter-wallet transfer system, wherein the request comprises first wallet server information, second wallet server information, and transaction information; receiving the amount in an intermediate account from the first user via the first wallet server, wherein the intermediate account was created in the inter-wallet transfer system during a registration of the first user with the inter-wallet transfer system and the intermediate account is associated with the first user; and sending the amount from the intermediate account to the second wallet server in response to the request, for completing a transaction between the first user associated with the first wallet server to the second user associated with the second wallet server.

In some non-limiting embodiments or aspects, the first wallet server information comprises at least a first wallet server name, a first wallet server identity (ID), a first currency supported by the first wallet server, and a first account associated with the first wallet server. In some non-limiting embodiments or aspects, the computer-implemented method further comprises: determining a currency exchange rate between the first currency and a second currency; receiving the amount in the intermediate account in the first currency; and sending the amount in the second currency to the second wallet server based on the currency exchange rate between the first currency and the second currency.

In some non-limiting embodiments or aspects, the second wallet server information comprises at least one of the following: a second wallet server name, a second wallet server ID, a second currency supported by the second wallet server, a second account associated with the second wallet server, or any combination thereof. In some non-limiting embodiments or aspects, the computer-implemented further comprises: determining a currency exchange rate between a first currency and the second currency; receiving the amount in the intermediate account in the first currency; and sending the amount in the second currency to the second wallet server based on the currency exchange rate between the first currency and the second currency. In some non-limiting embodiments or aspects, the second account is associated with at least one of a merchant and an individual user.

In some non-limiting embodiments or aspects, the transaction information comprises at least one of the following: the amount, a currency of transaction using the first wallet server, a currency supported by the second wallet server, a timestamp, a transaction ID, or any combination thereof. In some non-limiting embodiments or aspects, the request is received before or after scanning a unique code associated with the second wallet server. In some non-limiting embodiments or aspects, the unique code is at least one of the following: a name tag, bar code, a Quick Response (QR) code, a Near Field Communication (NFC) tag, or any combination thereof. In some non-limiting embodiments or aspects, the amount is transferred from the first wallet server to the intermediate account, and from the intermediate account to the second wallet server according to ISO 8583 standard and ISO 20022 standard.

In some non-limiting embodiments or aspects, the computer-implemented method further comprises: determining a currency exchange rate between a first currency and a second currency; receiving the amount in the intermediate account in the first currency; and sending the amount in the second currency to the second wallet server based on the currency exchange rate between the first currency and the second currency. In some non-limiting embodiments or aspects, the inter-wallet transfer system hosts an application, wherein the application performs one or more of the computer-implemented method steps.

In some non-limiting embodiments or aspects, provided is a computer-implemented method, comprising: receiving a plurality of registration details related to a plurality of wallets for registering with an inter-wallet transfer system; authenticating the plurality of registration details of the plurality of wallets based on a first set of parameters; creating an identity (ID) for each wallet after authenticating; and tokenizing the plurality of registration details, for storing the plurality of registration details and a plurality of tokens corresponding to the plurality of registration details in a first database associated with the inter-wallet transfer system. In some non-limiting embodiments or aspects, the plurality of registration details comprises at least one of the following: a name of the plurality of wallets, an address of the plurality of wallets, currency enabled in the plurality of wallets, or any combination thereof. In some non-limiting embodiments or aspects, the first set of parameters comprises at least one of the following: a risk score associated with the plurality of wallets, transaction patterns associated with the plurality of wallets, a transaction success rate associated with the plurality of wallets, or any combination thereof.

In some non-limiting embodiments or aspects, provided is a computer-implemented method, comprising: receiving a plurality of registration details related to a first user associated with a first wallet server associated with a first wallet among a plurality of wallets, for registering the first user with an inter-wallet transfer system, wherein the plurality of wallets are registered with the inter-wallet transfer system; authenticating the plurality of registration details related to the first user based on a second set of parameters; creating an identity (ID) for the first user after authenticating; tokenizing the plurality of registration details for storing the plurality of registration details and a plurality of tokens corresponding to the plurality of registration details in a second database associated with the inter-wallet transfer system; and creating an intermediate account in the inter-wallet transfer system, associated with the first user, wherein the inter-wallet transfer system initiates a transaction between a first wallet server and a second wallet server associated with a second wallet from the plurality of wallets, wherein a second user is associated with the second wallet server, wherein the first user generates a request in the inter-wallet transfer system for transferring an amount from the first wallet server to the second wallet server, wherein the request comprises first wallet server information, second wallet server information, and transaction information, wherein the inter-wallet transfer system receives the amount in the intermediate account from the first user via the first wallet server, wherein the inter-wallet transfer system sends the amount to the second wallet server from the intermediate account, in response to the request, for completing a transaction between the first user associated with the first wallet server to the second user associated with the second wallet server.

In some non-limiting embodiments or aspects, the plurality of registration details comprises at least one of the following: a name of the first user, an address of the first user, a preferred currency for transactions, Know Your Customer (KYC) details, or any combination thereof. In some non-limiting embodiments or aspects, the second set of parameters comprises at least one of the following: a risk score associated with the first user, transaction patterns associated with the first user, or any combination thereof.

In some non-limiting embodiments or aspects, a computer-implemented method for performing inter-wallet transactions is disclosed. The method comprises receiving a request from a first user associated with a first wallet server for transferring an amount from the first wallet server to a second wallet server. A second user may be associated with the second wallet server, and the first wallet server and the second wallet server correspond to a first wallet and a second wallet among a plurality of wallets registered with an inter-wallet transfer system. The request comprises first wallet server information, second wallet server information, and transaction information. The method further comprises receiving the amount in an intermediate account from the first user via the first wallet server. In some non-limiting embodiments or aspects, the intermediate account was created in the inter-wallet transfer system during a registration of the first user with the inter-wallet transfer system and the intermediate account is associated with the first user. The method further comprises sending the amount from the intermediate account to the second wallet server in response to the request, for completing a transaction between the first user associated with the first wallet server to the second user associated with the second wallet server.

In some non-limiting embodiments or aspects, a computer-implemented method for registering a wallet with an inter-wallet transfer system is proposed. The method comprises receiving a plurality of registration details related to a plurality of wallets for registering with the inter-wallet transfer system. Further, the method comprises authenticating the plurality of registration details of the plurality of wallets based on a first set of parameters. Thereafter, the method comprises creating an identity (ID) for each wallet after authenticating. Lastly, the method comprises tokenizing and storing the plurality of registration details and a plurality of tokens corresponding to the plurality of registration details in a first database associated with the inter-wallet transfer system.

In some non-limiting embodiments or aspects, provided is a computer-implemented method for registering a user associated with a wallet with an inter-wallet transfer system. The method comprises receiving a plurality of registration details related to a first user associated with a first wallet server associated with a first wallet among a plurality of wallets, for registering the first user with an inter-wallet transfer system. In some non-limiting embodiments or aspects, the plurality of wallets are registered with the inter-wallet transfer system. The method further comprises authenticating the plurality of registration details related to the first user based on a second set of parameters. The method further comprises creating an identity (ID) for the first user after authenticating. Further, the method comprises tokenizing the plurality of registration details for storing the plurality of registration details and a plurality of tokens corresponding to the plurality of registration details in a second database associated with the inter-wallet transfer system. Thereafter, the method comprises creating an intermediate account in the inter-wallet transfer system associated with the first user. The inter-wallet transfer system initiates a transaction between a first wallet server and a second wallet server associated with a second wallet from the plurality of wallets. In some non-limiting embodiments or aspects, the first user generates a request in the inter-wallet transfer system for transferring an amount from the first wallet server to the second wallet server, where the request comprises first wallet server information, second wallet server information, and transaction information, where the inter-wallet transfer system receives the amount in the intermediate account from the first user via the first wallet server, where the inter-wallet transfer system sends the amount to the second wallet server from the intermediate account, in response to the request, for completing a transaction between the first user associated with the first wallet server to the second user associated with the second wallet server.

Further non-limiting embodiments or aspects are set forth in the following numbered clauses:

Clause 1: A computer-implemented method, comprising: receiving a request from a first user associated with a first wallet server for transferring an amount from the first wallet server to a second wallet server, wherein a second user is associated with the second wallet server, wherein the first wallet server and the second wallet server correspond to a first wallet and a second wallet among a plurality of wallets registered with an inter-wallet transfer system, wherein the request comprises first wallet server information, second wallet server information, and transaction information; receiving the amount in an intermediate account from the first user via the first wallet server, wherein the intermediate account was created in the inter-wallet transfer system during a registration of the first user with the inter-wallet transfer system and the intermediate account is associated with the first user; and sending the amount from the intermediate account to the second wallet server in response to the request, for completing a transaction between the first user associated with the first wallet server to the second user associated with the second wallet server.

Clause 2: The computer-implemented method of clause 1, wherein the first wallet server information comprises at least a first wallet server name, a first wallet server identity (ID), a first currency supported by the first wallet server, and a first account associated with the first wallet server.

Clause 3: The computer-implemented method of clause 1 or 2, further comprising: determining a currency exchange rate between the first currency and a second currency; receiving the amount in the intermediate account in the first currency; and sending the amount in the second currency to the second wallet server based on the currency exchange rate between the first currency and the second currency.

Clause 4: The computer-implemented method of any of clauses 1-3, wherein the second wallet server information comprises at least one of the following: a second wallet server name, a second wallet server ID, a second currency supported by the second wallet server, a second account associated with the second wallet server, or any combination thereof.

Clause 5: The computer-implemented method of any of clauses 1-4, further comprising: determining a currency exchange rate between a first currency and the second currency; receiving the amount in the intermediate account in the first currency; and sending the amount in the second currency to the second wallet server based on the currency exchange rate between the first currency and the second currency.

Clause 6: The computer-implemented method of any of clauses 1-5, wherein the second account is associated with at least one of a merchant and an individual user.

Clause 7: The computer-implemented method of any of clauses 1-6, wherein the transaction information comprises at least one of the following: the amount, a currency of transaction using the first wallet server, a currency supported by the second wallet server, a timestamp, a transaction ID, or any combination thereof.

Clause 8: The computer-implemented method of any of clauses 1-7, wherein the request is received before or after scanning a unique code associated with the second wallet server.

Clause 9: The computer-implemented method of any of clauses 1-8, wherein the unique code is at least one of the following: a name tag, bar code, a Quick Response (QR) code, a Near Field Communication (NFC) tag, or any combination thereof.

Clause 10: The computer-implemented method of any of clauses 1-9, wherein the amount is transferred from the first wallet server to the intermediate account, and from the intermediate account to the second wallet server according to ISO 8583 standard and ISO 20022 standard.

Clause 11: The computer-implemented method of any of clauses 1-10, further comprising: determining a currency exchange rate between a first currency and a second currency; receiving the amount in the intermediate account in the first currency; and sending the amount in the second currency to the second wallet server based on the currency exchange rate between the first currency and the second currency.

Clause 12: The computer-implemented method of any of clauses 1-11, wherein the inter-wallet transfer system hosts an application, wherein the application performs one or more of the computer-implemented method steps.

Clause 13: A computer-implemented method, comprising: receiving a plurality of registration details related to a plurality of wallets for registering with an inter-wallet transfer system; authenticating the plurality of registration details of the plurality of wallets based on a first set of parameters; creating an identity (ID) for each wallet after authenticating; and tokenizing the plurality of registration details, for storing the plurality of registration details and a plurality of tokens corresponding to the plurality of registration details in a first database associated with the inter-wallet transfer system.

Clause 14: The computer-implemented method of clause 13, wherein the plurality of registration details comprises at least one of the following: a name of the plurality of wallets, an address of the plurality of wallets, currency enabled in the plurality of wallets, or any combination thereof.

Clause 15: The computer-implemented method of clause 12 or 13, wherein the first set of parameters comprises at least one of the following: a risk score associated with the plurality of wallets, transaction patterns associated with the plurality of wallets, a transaction success rate associated with the plurality of wallets, or any combination thereof.

Clause 16: A computer-implemented method, comprising: receiving a plurality of registration details related to a first user associated with a first wallet server associated with a first wallet among a plurality of wallets, for registering the first user with an inter-wallet transfer system, wherein the plurality of wallets are registered with the inter-wallet transfer system; authenticating the plurality of registration details related to the first user based on a second set of parameters; creating an identity (ID) for the first user after authenticating; tokenizing the plurality of registration details for storing the plurality of registration details and a plurality of tokens corresponding to the plurality of registration details in a second database associated with the inter-wallet transfer system; and creating an intermediate account in the inter-wallet transfer system, associated with the first user, wherein the inter-wallet transfer system initiates a transaction between a first wallet server and a second wallet server associated with a second wallet from the plurality of wallets, wherein a second user is associated with the second wallet server, wherein the first user generates a request in the inter-wallet transfer system for transferring an amount from the first wallet server to the second wallet server, wherein the request comprises first wallet server information, second wallet server information, and transaction information, wherein the inter-wallet transfer system receives the amount in the intermediate account from the first user via the first wallet server, wherein the inter-wallet transfer system sends the amount to the second wallet server from the intermediate account, in response to the request, for completing a transaction between the first user associated with the first wallet server to the second user associated with the second wallet server.

Clause 17: The computer-implemented method of clause 16, wherein the plurality of registration details comprises at least one of the following: a name of the first user, an address of the first user, a preferred currency for transactions, Know Your Customer (KYC) details, or any combination thereof.

Clause 18: The computer-implemented method of clause 16 or 17, wherein the second set of parameters comprises at least one of the following: a risk score associated with first user, transaction patterns associated with the first user, or any combination thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are set forth in the appended claims. The disclosure itself, however, as well as a preferred mode of use, further objectives, and advantages thereof, may best be understood by reference to the following detailed description of non-limiting embodiments or aspects when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments or aspects are now described, by way of example only, with reference to the accompanying figures wherein like reference numerals represent like elements and in which:

FIG. 1 is an exemplary illustration for performing inter-wallet transactions, in accordance with some non-limiting embodiments or aspects of the present disclosure;

FIG. 2 is an exemplary core system architecture of implementing inter-wallet transactions, in accordance with some non-limiting embodiments or aspects of the present disclosure;

FIG. 3 is an exemplary method for registering wallets with the inter-wallet transfer system, in accordance with some non-limiting embodiments or aspects of the present disclosure;

FIG. 4 is an exemplary method for registering a wallet user with the inter-wallet transfer system, in accordance with some non-limiting embodiments or aspects of the present disclosure;

FIG. 5 is an exemplary method for performing the inter-wallet transactions, in accordance with some non-limiting embodiments or aspects of the present disclosure;

FIG. 6A and FIG. 6B are an exemplary application for registering wallets with the inter-wallet transaction, in accordance with some non-limiting embodiments or aspects of the present disclosure

FIG. 6C and FIG. 6D are an exemplary application for registering wallet users with the inter-wallet transaction, in accordance with some non-limiting embodiments or aspects of the present disclosure;

FIG. 6E, FIG. 6F, FIG. 6G, FIG. 6H, FIG. 7 and FIG. 8 are an exemplary application for making a transaction between two wallets, in accordance with some non-limiting embodiments or aspects of the present disclosure; and

FIG. 9 is a general-purpose computer system for enabling inter-wallet transactions, in accordance with some non-limiting embodiments or aspects of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer-readable medium and executed by a computer or processor, whether or not such computer or processor is explicitly shown. While each of the figures illustrates a particular embodiment or aspect for purposes of illustrating a clear example, other embodiments may omit, add to, reorder, and/or modify any of the elements shown in the figures.

### DETAILED DESCRIPTION

In the present document, the term “exemplary” is used herein to mean “serving as an example, instance, or illustration.” Any embodiment, aspect, or implementation of the present subject matter described herein as “exemplary” is not necessarily to be construed as preferred or advantageous over other embodiments.

In the following detailed description of non-limiting embodiments or aspects of the disclosure, reference is made to the accompanying drawings that form a part hereof, and in which are shown by way of illustration specific embodiments in which the disclosure may be practiced. It should be understood, however, that it is not intended to limit the disclosure to the forms disclosed, but on the contrary, the disclosure is to cover all modifications, equivalents, and alternatives falling within the spirit and the scope of the disclosure. It is to be understood that other embodiments may be utilized and that changes may be made without departing from the scope of the present disclosure. The following description is, therefore, not to be taken in a limiting sense.

The terms “comprises”, “comprising”, or any other variations thereof are intended to cover a non-exclusive inclusion such that a setup, device, or method that comprises a list of components or steps does not include only those components or steps but may include other components or steps not expressly listed or inherent to such setup, device, or method. In other words, one or more elements in a system or apparatus proceeded by “comprises . . . a” does not, without more constraints, preclude the existence of other elements or additional elements in the system or method.

The terms “includes”, “including”, or any other variations thereof are intended to cover a non-exclusive inclusion such that a setup, device, or method that includes a list of components or steps does not include only those components or steps but may include other components or steps not expressly listed or inherent to such setup, device, or method. In other words, one or more elements in a system or apparatus proceeded by “includes . . . a” does not, without more constraints, preclude the existence of other elements or additional elements in the system or method.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has”, “have”, “having”, or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

As used herein, the terms “communication”, “communicate”, “send”, and/or “receive” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “server” and/or “processor” may refer to one or more computing devices or computing units, such as processors, storage devices, and/or similar computer components, that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor”, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure relate to methods and a system for performing inter wallet transactions. The present disclosure provides methods and systems for enabling inter wallet transactions. The system provides an application for enabling inter-wallet transactions. A plurality of wallets is registered with the application and a plurality of users associated with one or more of the plurality of wallets are also registered with the application. An intermediate account is created in the application for each user. When a first user associated with a first wallet among the plurality of wallets initiates a transaction to be made to a second user associated with a second wallet among the plurality of wallets, the application debits an amount to the intermediate account in the application and transfers the amount to the second user associated with the second wallet. Therefore, seamless transactions can be made between any wallets registered with the system.

FIG. 1 represents an environment (100) for performing inter-wallet transactions. The environment (100) comprises a plurality of wallet servers (102, 104) associated with a respective plurality of wallets, a plurality of wallet users (101, 105), and an inter-wallet transfer system (103). “Wallet user” and “user” may be interchangeably used in the present disclosure. Likewise, “wallet” and “wallet server” may be used interchangeably used in the present disclosure. The present disclosure pertains to an inter-wallet transfer system (103). According to this description, wallets are entities that provide or facilitate wallet transaction services and wallet servers are computing devices that enable the wallet transaction services.

The inter-wallet transfer system (103) enables transactions between the plurality of wallet servers (102, 104). For example, the inter-wallet transfer system (103) can be used when a transaction is initiated between a first wallet server (102) and a second wallet server (104). In some non-limiting embodiments or aspects, the inter-wallet transaction system (103) may comprise an inter-wallet transfer application (not shown) and an inter-wallet transfer server (not shown). The inter-wallet transfer application may be installed in electronic devices of the plurality of wallet users (101, 105). The inter-wallet transfer server may be a centralized computing unit or a distributed computing unit configured to provide the services to enable transactions between the plurality of wallet servers (102, 104).

In a typical wallet-to-wallet transaction, flow of a transaction begins with a first wallet user (101) initiating a transaction in an electronic device. In some non-limiting embodiments or aspects, the first wallet user (101) may enter recipient details, such as second wallet server name and second wallet username and/or number in the electronic device. In some non-limiting embodiments or aspects, the first wallet user may scan a code to retrieve details of the second wallet user (105). Once the details of the second wallet user (105) are entered or retrieved, the first wallet user (101) authenticates the transaction and completes the transaction. In the present disclosure, the first wallet user (101) initiates the transaction using the inter-wallet transfer application. The first wallet user (101) selects the first wallet and the select wallet in the inter-wallet transfer system to initiate the transaction. Further, the first wallet user (101) also enters the details of the second wallet user (105). The details of the second wallet user (105) may be entered as described above. Further, a transaction amount is entered in the inter-wallet transfer application. Thereafter, the inter-wallet transfer application sends the transaction amount from the first wallet server (102) to the second wallet server (104). An advantage of the present disclosure is that a plurality of wallet applications need not be installed in the electronic device, as the inter-wallet transfer application can be used to transfer the amount between the plurality of wallets.

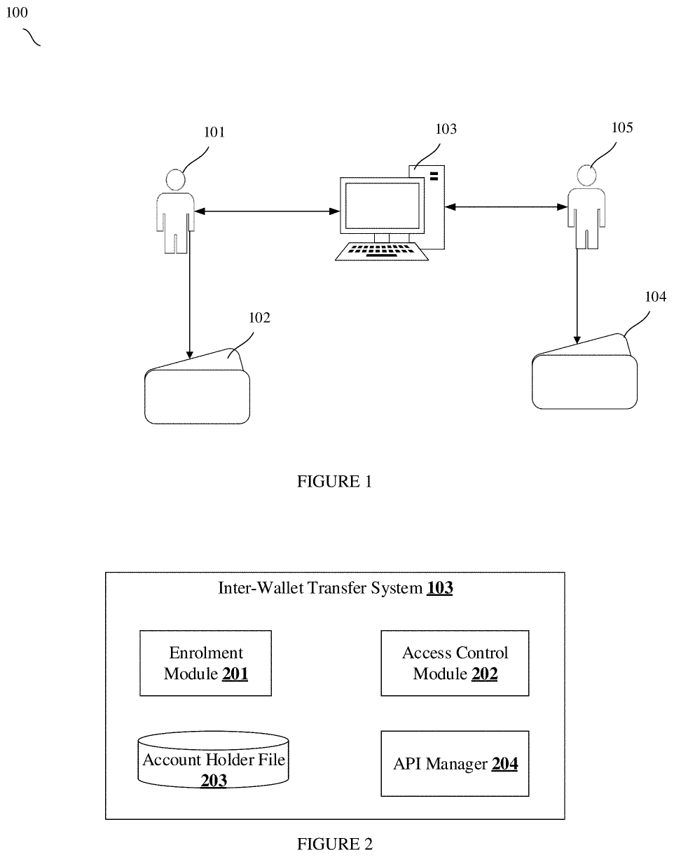

FIG. 2 illustrates some non-limiting embodiments or aspects of a core system architecture of the inter-wallet transfer system (103). The core system architecture includes at least an enrollment module (201), an Access Control Module (ACM) (202), an account holder file (203), and an Application Program Interface (API) manager (204). In some non-limiting embodiments or aspects, the above modules may reside inside the inter-wallet transfer server.

In some non-limiting embodiments or aspects, the enrollment module (201) is a computing unit, for example, a computer that manages a wallet's enrollment and a wallet user's enrollment into the inter-wallet transfer system (103) by presenting a series of questions (for example, via a web interface or via the inter-wallet transfer application) to be answered by a representative of each of the plurality of wallets (102, 104) and each of the plurality of the wallet users (101, 105). In some non-limiting embodiments or aspects, the enrollment module (201) verifies the data provided by the plurality of wallet servers (102, 104) and the plurality of wallet users (101, 105). In some non-limiting embodiments or aspects, the plurality of wallet servers (102, 104) would have verified respective wallet users (101, 105). Hence, the enrollment module (201) may use the verified data of the wallet users (101, 105) for verifying the plurality of wallet users (101, 105) during registration.

In some non-limiting embodiments or aspects, the ACM (202) is a computer that has a database of the plurality of wallets (102, 104) and the plurality of wallet users (101, 105) registered with the inter-wallet transfer system (103). During a wallet transaction between the first wallet (102) and the second wallet (104), the ACM (202) may access the first wallet server (102) to receive transaction authentication and transaction authorization confirmation. Only when the ACM (202) receives the transaction authentication and transaction authorization, the transaction is completed by transferring a transaction amount to the second wallet server (104).

In some non-limiting embodiments or aspects, the ACM (202) may receive digitally-signed receipts from a sending wallet server (e.g., 102) when a transaction is initiated by a wallet user (e.g., 101) to send a transaction amount to a second user (e.g., 105) of a second wallet server (e.g., 104). Further, the ACM (202) may confirm that the transaction amount is debited to the intermediate account associated with the wallet user (101). Further, the ACM (202) may send a digitally signed receipt to the second wallet server (e.g., 104) and particularly to the second wallet user (105) of the second wallet (104).

In some non-limiting embodiments or aspects, an account holder file (203) is a database for storing information relating to the plurality of wallets (102, 104) and the plurality of users (101, 105). The account holder file (203) is updated when a new wallet or a new user is registered with the inter-wallet transfer system (103). In some non-limiting embodiments or aspects, the inter-wallet transfer application is installed in the electronic device of a wallet user (e.g., 101) and is connected to the inter-wallet transfer server via the Internet.

In some non-limiting embodiments or aspects, an API manager (204) is used to invoke a wallet application (e.g., sender wallet application) to complete the transaction. In some non-limiting embodiments or aspects, the sender wallet application may be a mobile application or a web application. For instance, the sender may not install wallet application. The API manager invoke the sender wallet server (e.g., 102) and the sender wallet server may request the sender to authorize the transaction, without leaving the inter-wallet transfer application. In some non-limiting embodiments or aspects, the API manager (204) toggles a user interface of the electronic device from the inter-wallet transfer application to the sender wallet application. The sender wallet user provides necessary details in the sender wallet application to initiate the transaction amount. When the sender wallet user provides the necessary details in the sender wallet application, the transaction amount is credited into the intermediate account of the sender wallet user in the inter-wallet transfer application. Also, the API manager (204) toggles the user interface back to the inter-wallet transfer application. Thereafter, when the transaction amount is credited into the intermediate account, the inter-wallet transfer application transfers the transaction amount to a receiver wallet server (e.g., 104), more specifically, to a receiver wallet user (e.g., 105).

In some non-limiting embodiments or aspects, an inter wallet transaction is useful in a scenario when a first user has to transfer an amount to a second user. Conventionally, wallet transfers are possible when a sender and a receiver are associated with a common wallet. The inter-wallet transfer application enables the sender to make transactions with the receiver although different respective wallets are used.

In some non-limiting embodiments or aspects, the inter-wallet transfer system (103) is associated with a Common Directory of Aliases (CDA) database (not shown). In some non-limiting embodiments or aspects, the CDA may be hosted in the inter-wallet transfer system (103) or in a dedicated CDA server (not shown). The CDA database comprises a unique ID and aliases for each wallet server and each wallet user. In some non-limiting embodiments or aspects, the unique ID of each wallet server may be similar to a Bank Identification Number (BIN) or a cryptographically-generated unique token/key. In some non-limiting embodiments or aspects, each wallet user is provided with an alias. The alias is used as a security feature to represent the wallet username. In some non-limiting embodiments or aspects, a plurality of details of a plurality of wallet servers (102, 104) and a plurality of wallet users (101, 105) are stored in the CDA database in a tokenized manner. In some non-limiting embodiments or aspect, JSON Web Token (JWT) standard tokens are generated. A person skilled in the art will appreciate that any technique can be employed for generating tokens and the present disclosure is not limited to generating tokens using JWT standard alone.

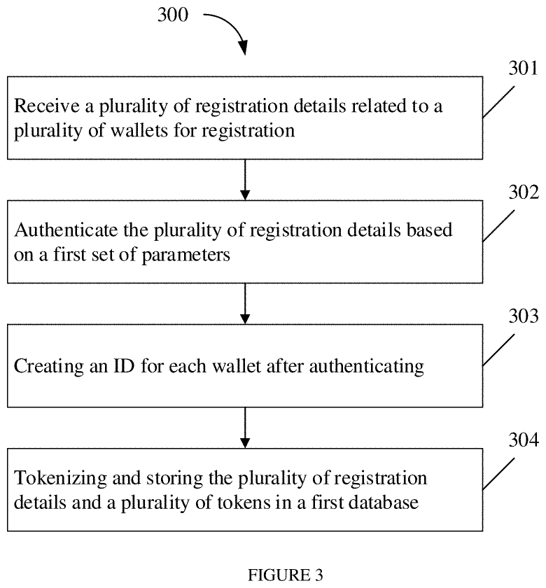

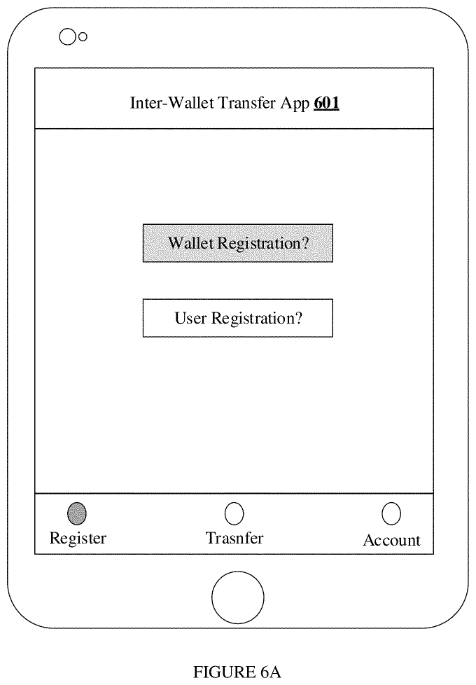

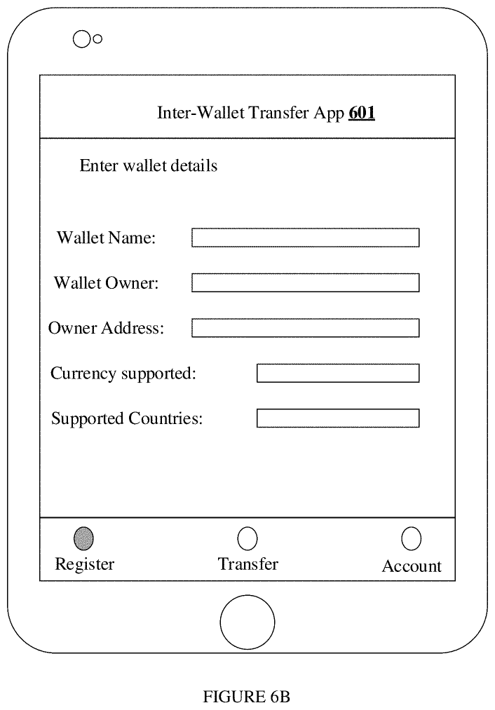

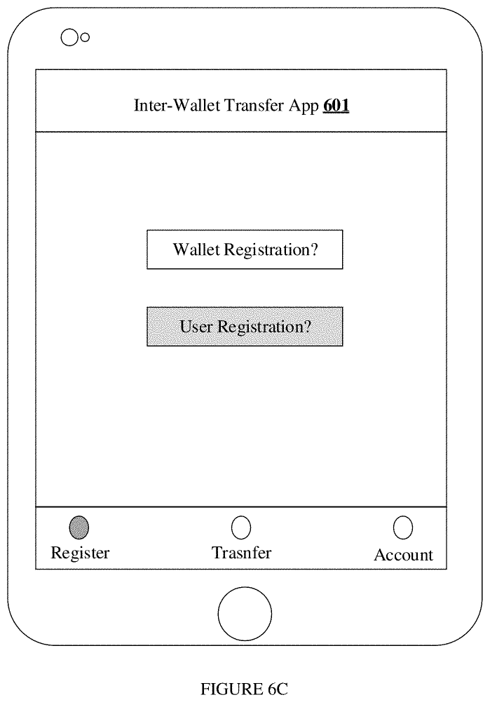

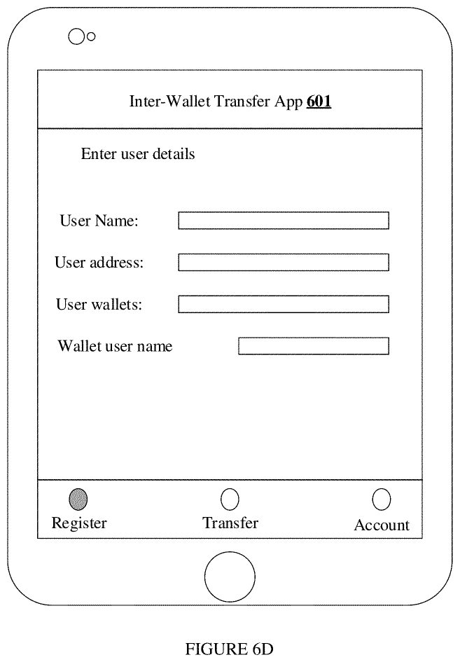

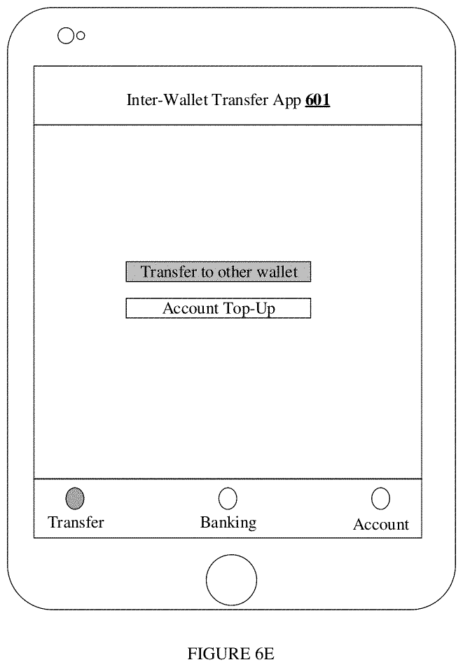

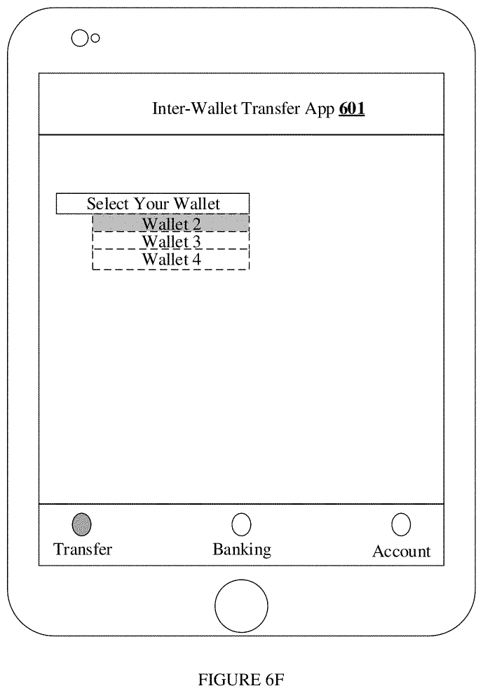

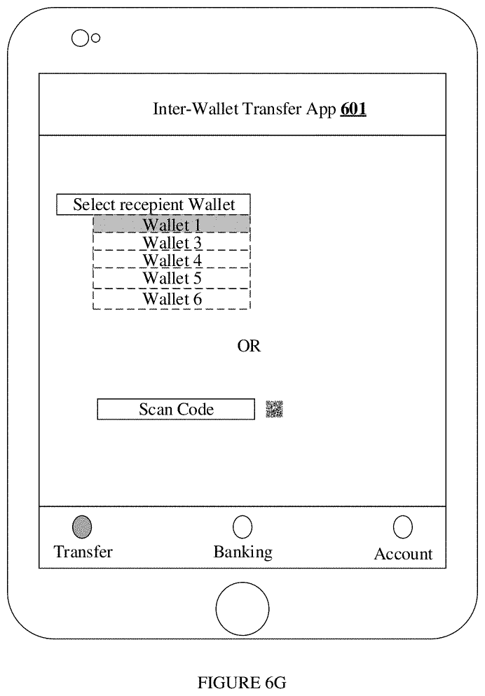

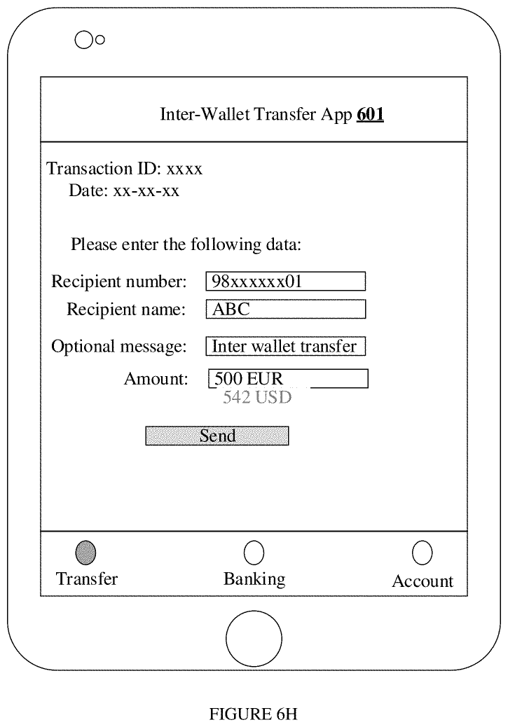

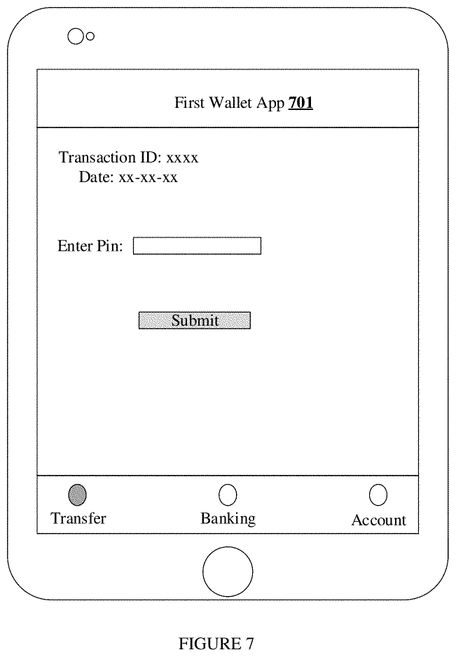

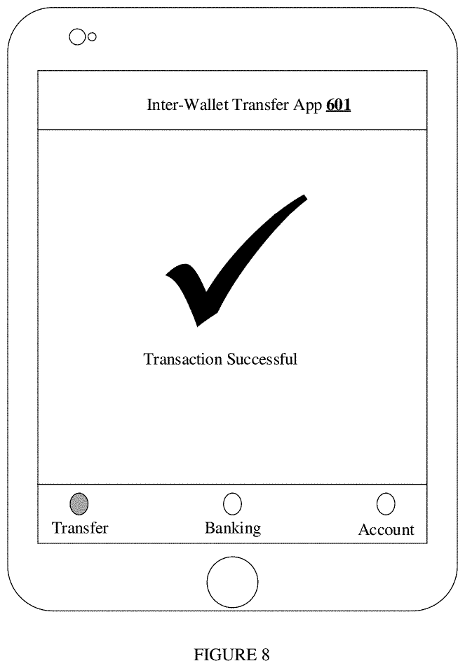

FIG. 3 illustrates exemplary method steps for registering the plurality of wallets (102, 104) with the inter-wallet transfer system (103). As illustrated in FIG. 3, the method (300) may comprise one or more steps. The method (300) may be described in the general context of computer executable instructions. Generally, computer-executable instructions can include routines, programs, objects, components, data structures, procedures, modules, and functions, which perform particular functions or implement particular abstract data types. The method of FIG. 3 is described by making reference to FIG. 6A and FIG. 6B, which illustrate the inter-wallet transfer application (601) for registering the plurality of wallets (102, 104).

At step (301), a plurality of registration details related to the plurality of wallets (102, 104) is received. The inter-wallet transfer system (103) facilitates transactions between the plurality of wallet servers (102, 104) registered with the inter-wallet transfer system (103). Reference is now made to FIG. 6A showing the inter-wallet transfer application (601). The illustration of FIG. 6A is an exemplary page showing an option for registering a wallet (e.g., 102) or a user (e.g., 101). As shown in FIG. 6A, a wallet registration button is selected. The illustration of FIG. 6B is an exemplary page showing fields for entering a plurality of registration details of the wallet (e.g., 102). Likewise, the plurality of wallets (102, 104) can be registered with the inter-wallet transfer system (103) by entering respective plurality of registration details in the inter-wallet transfer system (103). The plurality of details can include, but is not limited to, wallet name, wallet office address, name and contact persons of wallet, Know Your Customer (KYC) details, country of using the wallet, currency supported by the wallet, maximum transaction limit, minimum transaction limit, supported wallets, settlement entity details, and the like. The fields shown in FIG. 6B are examples and should not be considered as a limitation. The fields shown in FIG. 6B are plurality of questions provided by the enrollment module (201). The plurality of questions may be provided in the inter-wallet transfer application (601) as shown in the FIG. 6B or in the web interface (not shown).

Referring back to FIG. 3, at step (302), the plurality of registration details of the plurality of wallets (102, 104) is authenticated based on a first set of parameters. In some non-limiting embodiments or aspects the first set of parameters comprises at least one of a risk score associated with the plurality of wallets (102, 104), transaction patterns associated with the plurality of wallets (102, 104), and a transaction success rate associated with the plurality of wallets (102, 104). The enrollment module (201) verifies the plurality of registration details provided by the plurality of wallet servers (102, 104). In an example, the enrollment module (201) may compare the registration details of the plurality of wallets (102, 104) with Government recognized details to authenticate the plurality of details. Likewise, the enrollment module (201) may verify the plurality of registration details in many known ways.

At step (303), an ID for each wallet is created after authenticating. Once the plurality of details of the plurality of wallets (102, 104) is authenticated, a unique ID is created for each wallet among the plurality of wallets (102, 104). The enrollment module (201) may create the unique ID for each wallet. The unique ID is used to represent the respective wallet while making transactions.

At step (304), the plurality of registration details and a plurality of tokens are tokenized and stored in a first database. The enrollment module (201) generates a plurality of tokens for the plurality of registration details of the plurality of wallets (102, 104). The plurality of tokens may be generated for example in the JWT standard. Tokenizing the information provides security. In some non-limiting embodiments or aspects, during a transaction, the plurality of tokens is included in the transaction message. Thus, the wallet name or wallet username is not disclosed anywhere during the transaction. The plurality of registration details and the plurality of tokens are mapped and stored in the first database (not shown in the figures). In some non-limiting embodiments or aspects, the first database is the CDA database.

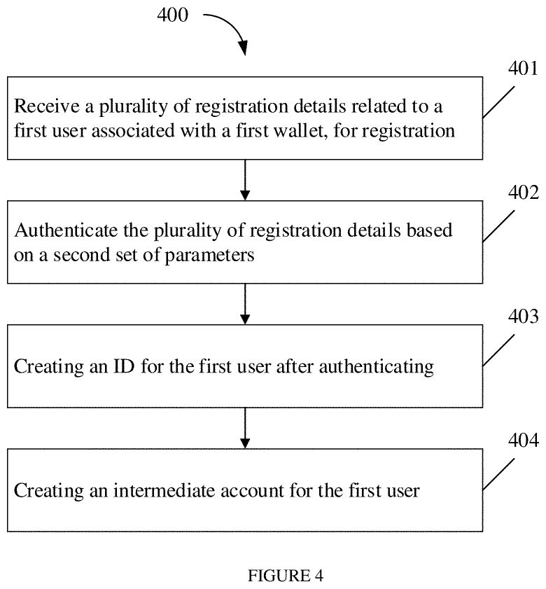

FIG. 4 illustrates exemplary method steps for registering the plurality of wallet users (101, 105) with the inter-wallet transfer system (103). As illustrated in FIG. 4, the method (400) may comprise one or more steps. The method (400) may be described in the general context of computer-executable instructions. Generally, computer-executable instructions can include routines, programs, objects, components, data structures, procedures, modules, and functions, which perform particular functions or implement particular abstract data types. The method of FIG. 4 is described by making reference to FIG. 6C and FIG. 6D, which illustrate the inter-wallet transfer application (601) for registering the plurality of wallet users (101, 105).

At step (401), a plurality of registration details related to a wallet user (101) is received. In some non-limiting embodiments or aspects, it is obvious to a person skilled in the art that the registration details of the plurality of wallet users (101, 105) can also be received by the inter-wallet transfer system (103). The inter-wallet transfer system (103) facilitates transactions between the plurality of wallet users (101, 105) registered with the inter-wallet transfer system (103). Reference is now made to FIG. 6C showing the inter-wallet transfer application (601). The illustration of FIG. 6C is an exemplary page showing an option for registering a wallet (e.g., 102) or a user (e.g., 101). As shown in FIG. 6C, a wallet user registration button is selected. The illustration of FIG. 6D is an exemplary page showing fields for entering a plurality of registration details of the wallet user (e.g., 101). Likewise, the plurality of wallet users (101, 105) can be registered with the inter-wallet transfer system (103) by entering a respective plurality of registration details in the inter-wallet transfer system (103). The plurality of details can include, but are not limited to, name and address of the wallet user, a preferred currency for transactions, KYC details, and the like. The fields shown in FIG. 6D are examples and should not be considered as a limitation. The fields shown in FIG. 6D are a plurality of questions provided by the enrollment module (201). The plurality of questions may be provided in the inter-wallet transfer application (601) as shown in FIG. 6D or in the web interface (not shown).

Referring back to FIG. 4, at step (402), the plurality of registration details of the plurality of wallet users (101, 105) is authenticated based on a second set of parameters. The second set of parameters comprises at least one of a risk score associated with the wallet user (e.g., 101) and transaction patterns associated with the wallet user (e.g., 101). The enrollment module (201) verifies the plurality of registration details provided by the plurality of wallet users (101, 105). In an example, the enrollment module (201) may compare the registration details of the plurality of wallet users (101, 105) with Government recognized details to authenticate the plurality of details. Likewise, the enrollment module (201) may verify the plurality of registration details in many known ways. In some non-limiting embodiments or aspects, each wallet (e.g., 102) would have authenticated respective wallet users (e.g., 101). The enrollment module (201) may use the authentication details of the wallet user (e.g., 101) from the corresponding wallet (e.g., 102) to authenticate the wallet user (e.g., 101).

At step (403), an ID for each wallet user (e.g., 101) is created after authenticating. Once the plurality of details of the plurality of wallet users (101, 105) is authenticated, a unique ID is created for each wallet user (e.g., 101) among the plurality of wallet users (101, 105). The enrollment module (201) may create the unique ID for each wallet user (e.g., 101). The unique ID is used to represent the respective wallet user (e.g., 101) while making transactions. Further, the enrollment module (201) may create an alias for each wallet user (e.g., 101). In some non-limiting embodiments or aspects, the alias can be a random string and each alias is mapped to a wallet user. In some non-limiting embodiments or aspects, the alias can comprise a combination of characters and numbers. For example, the first wallet user alias may be “abcd” and the second wallet user alias may be “wxyz”. In some non-limiting embodiments or aspects, the alias can include the unique ID of a corresponding wallet. Thus, the mapping between the wallet user and corresponding wallet is represented in the alias.

At step (404), an intermediate account is created for each of the plurality of wallet users (101, 105). The intermediate account is used to enable the inter-wallet transactions. The intermediate account can be topped up with an amount and can be used by respective wallet user, for e.g., the first wallet user (101) associated with the first wallet server (102) to transfer to the second wallet user (105) associated with the second wallet server (104). In some non-limiting embodiments or aspects, when the first wallet user (101) initiates a transaction, the intermediate account of the first user (101) is debited with a transaction amount from the first wallet server (102) and then the transaction amount is transferred to the second user (105) of the second wallet server (104).

In some non-limiting embodiments or aspects, the enrollment module (201) generates a plurality of tokens for the plurality of registration details of the plurality of wallet users (101, 105). The plurality of tokens may be generated for example in the JWT standard. The plurality of registration details and the plurality of tokens are mapped and stored in the second database (not shown in the figures). In some non-limiting embodiments or aspects, the second database is the CDA database. In some non-limiting embodiments or aspects, the account holder file (203) may be stored in the first and the second databases.

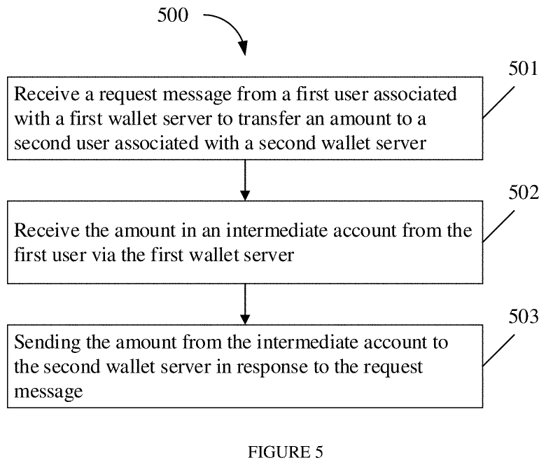

FIG. 5 illustrates exemplary method steps for enabling inter-wallet transactions. As illustrated in FIG. 5, the method (500) may comprise one or more steps. The method (500) may be described in the general context of computer executable instructions. Generally, computer executable instructions can include routines, programs, objects, components, data structures, procedures, modules, and functions, which perform particular functions or implement particular abstract data types. The method of FIG. 5 described by making reference to FIG. 6E, FIG. 6F, FIG. 6G, FIG. 6H, FIG. 7, and FIG. 8, which illustrate the inter-wallet transfer application (601) for enabling transactions between the plurality of wallet servers (102, 104). The following description is described considering that the first wallet user (101) has initiated the transaction to transfer the transaction amount to the second wallet user (105).

At step (501), a request is received from the first wallet user (101) to transfer an amount to the second wallet user (105). In some non-limiting embodiments or aspects, the request comprises first wallet server information, second wallet server information, and transaction information. The first wallet server information comprises at least a first wallet server name, a first wallet server ID, a first currency supported by the first wallet server, and a first account associated with the first wallet server. The second wallet server information comprises at least a second wallet server name, a second wallet server ID, a second currency supported by the second wallet server, and a second account associated with the second wallet server. The transaction information comprises at least the amount, a currency of transaction using the first wallet server, a currency supported by the second wallet server, a timestamp, and a transaction ID.

Reference is now made to FIG. 6E which shows the inter-wallet transfer application (601) to initiate the inter-wallet transaction. As shown, in FIG. 6E, the “transfer to other wallet” option is selected. FIG. 6F illustrates an exemplary page of the inter-wallet transfer application (601) when the “transfer to other wallet” option is selected. As shown in FIG. 6F, the first wallet user (101) is prompted to select the first wallet (102). In some non-limiting embodiments or aspects, if the first wallet user (101) has entered only one wallet (e.g., 102) in the inter-wallet transfer application (601) during the registration, the entered wallet (102) is selected by default. In some non-limiting embodiments or aspects, if the first wallet user (101) has entered a plurality of wallets (102, 104) in the inter-wallet transfer application (601) during the registration, the first wallet user (101) is prompted to select a wallet (e.g., 102) from the plurality of wallets (102, 104), as shown in FIG. 6F.

Reference is now made to FIG. 6G and FIG. 6H showing the inter-wallet transfer application (601) for entering details regarding the recipient (e.g., the second wallet user (105)). In some non-limiting embodiments or aspects, the recipient may be associated with a second wallet account. In some non-limiting embodiments or aspects, the recipient may be a merchant or an individual user. As shown in FIG. 6G, the recipient wallet (e.g., the second wallet (104)) may be selected from the list of the plurality of wallets (102, 104) or may be retrieved by scanning a machine readable code (also referred as unique code), such as a name tag, an Near Field Communication (NFC) tag, a bar code, a Quick Response (QR) code, and the like, associated with the second wallet server (104). It will be obvious to a person of ordinary skills that, when a machine-readable code associated with a recipient wallet is scanned, recipient wallet details as well as recipient wallet user details are retrieved. In some non-limiting embodiments or aspects, the request from the first wallet user (101) may be received after scanning the machine-readable code or before scanning the machine-readable code. Hence, the illustration of FIG. 6H may occur when the first user (101) manually selects the recipient wallet as shown in FIG. 6G. As shown in FIG. 6H, fields for entering a plurality of details regarding the second wallet user (105) are provided. The fields illustrated in FIG. 6H should not be considered as a limitation and the fields can include other details that are commonly known to a person skilled in the art. An example of the details of the second wallet user (105) may be the second wallet user name “ABC”, a second wallet user number “98xxxxxxx892”, and the like. Further, the first wallet user (101) may also enter an optional message as shown in FIG. 6H. Further, the first wallet user (101) has to enter the transaction amount to be transferred to the second wallet user (105). As shown in FIG. 6H, the amount is 500 Euros. In some non-limiting embodiments or aspects, the first wallet user (101) may also choose a currency while entering the transaction amount (not shown in FIG. 6H).

In some non-limiting embodiments or aspects, when the first wallet user (101) scans the machine readable code associated with the second wallet server (104) or manually selects the second wallet (104), the currency of the transaction may be determined by the inter-wallet transfer application (601) based on the registration details of the second wallet (104). In some non-limiting embodiments or aspects, the inter-wallet transfer application (601) may provide a currency exchange rate between a first currency associated with the first wallet (102) and a second currency associated with the second wallet (104) as shown in FIG. 6H. Hence, the first wallet user (101) may determine the transaction amount to enter according to the second currency. Once the first wallet user (101) has entered the transaction amount, the first wallet user (101) can confirm to make the transaction. A “send” button may be provided in the inter-wallet transfer application (601) as shown in FIG. 6H.

Reference is now made to FIG. 7 which illustrates a first wallet application (701). When the first wallet user (101) confirms the payment of the transaction amount, the API manager (204) may make an API call to the first wallet application (701) for debiting the transaction amount from the first wallet application (701). As shown in FIG. 7, the first wallet application (701) provides a field to enter a password to before debiting the transaction amount. The password may be a One Time Password (OTP) or a 3-D secure password or any other type of password commonly supported by the wallets. When the first wallet user (101) enters the password in the first wallet application (701), the password is verified by the wallet and the transaction amount is debited from a first wallet user account.

Referring back to FIG. 5, at step (502) the transaction amount is received in the intermediate account associated with the first wallet user (101) from the first wallet server (102). When the transaction amount is debited from the first wallet server (102), the ACM (202) receives a receipt from the first wallet server (102) indicating the successful debiting of the transaction amount. The transaction amount is received in the intermediate account associated with the first wallet user (101). The ACM (202) then verifies if the transaction amount is credited to the intermediate account. In some non-limiting embodiments or aspects, the amount is transferred from the first wallet server (102) to the account, and from the account to the second wallet server (104) according to ISO 8583 standard and ISO 20022 standard.

In some non-limiting embodiments or aspects, the first wallet user (101) can top-up the intermediate account with an amount before initiating a transaction. When the first wallet user (101) initiates the transaction to the second wallet user (105), the amount present in the intermediate account can be used to complete the transaction.

At step (503), the transaction amount is sent from the intermediate account to the second wallet user (105). When the ACM (202) verifies that the transaction amount is credited in the intermediate account, the transaction amount is sent to the second wallet server (104). Particularly, the transaction amount is sent to the second wallet user account. The ACM (202) may receive a receipt from the second wallet server (104) indicating that the transaction amount has been credited to the second wallet user account. Once the transaction amount is credited to the second wallet user account, the inter-wallet transfer application (601) displays a suitable message to the first wallet user (101). An example of the message displayed to the first wallet user (101) is illustrated in FIG. 8.

In some non-limiting embodiments or aspects, the inter-wallet transfer system (103) enables interoperability between the plurality of wallet servers (102, 104). Also, the inter-wallet transfer system (103) may comprise a currency converting technique to convert the first currency to the second currency. The inter-wallet transfer system (103) assists in making transactions with cross-border wallets. In some non-limiting embodiments or aspects, the inter-wallet transfer system (103) may facilitate trade between the first wallet user (101) and the second wallet user (105). The inter-wallet transfer system (103) may be maintained by service organizations, such as Visa®. The inter-wallet transfer system (103) may also support crypto-currencies.

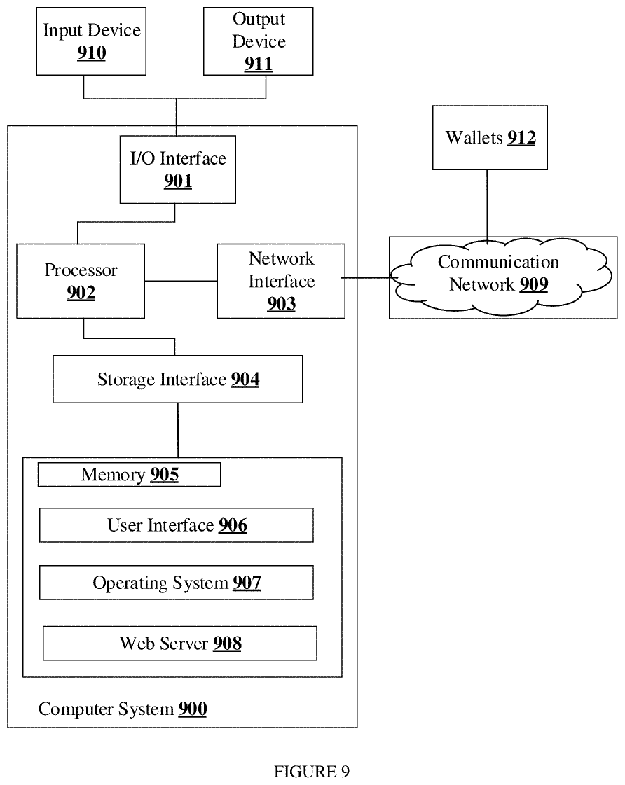

FIG. 9 illustrates a block diagram of an exemplary computer system (900) for implementing embodiments consistent with the present disclosure. In some non-limiting embodiments or aspects, the computer system (900) is used to implement the method for performing inter wallet transaction. In some non-limiting embodiments or aspects, the computer system (900) may implement the functionalities of the inter-wallet transfer system (103). The computer system (900) may comprise a central processing unit (“CPU” or “processor”) (902). The processor (902) may comprise at least one data processor for executing program components for dynamic resource allocation at run time. The processor (902) may include specialized processing units, such as integrated system (bus) controllers, memory management control units, floating point units, graphics processing units, digital signal processing units, etc.

The processor (902) may be disposed in communication with one or more input/output (I/O) devices (not shown) via an I/O interface (901). The I/O interface (901) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax®, or the like), etc.

Using the I/O interface (901), the computer system 900 may communicate with one or more I/O devices. For example, an input device (910) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (911) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some non-limiting embodiments or aspects, the computer system (900) is connected to the service operator through a communication network (909). The processor (902) may be disposed in communication with the communication network (909) via a network interface (903). The network interface (903) may communicate with the communication network (909). The network interface (903) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (909) may include, without limitation, a direct interconnection, e-commerce network, a peer to peer (P2P) network, local area network (LAN), wide area network (WAN), wireless network (e.g., using Wireless Application Protocol), the Internet, Wi-Fi®, etc. Using the network interface (903) and the communication network (909), the computer system (900) may communicate with the one or more service operators.

In some non-limiting embodiments or aspects, the processor (902) may be disposed in communication with a memory (905) (e.g., RAM, ROM, etc. not shown in FIG. 9) via a storage interface (904). The storage interface (904) may connect to memory (905) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (905) may store a collection of program or database components, including, without limitation, a user interface (906), an operating system (907), web server (908), etc. In some non-limiting embodiments or aspects, computer system (900) may store user/application data, such as the data, variables, records, etc. as described in this disclosure. Such databases may be implemented as fault-tolerant, relational, scalable, secure databases such as Oracle or Sybase.

The operating system (907) may facilitate resource management and operation of the computer system (900). Examples of operating systems include, without limitation, Apple Macintosh® OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows® (XP, Vista/7/8, 10 etc.), Apple® iOS, Google® Android, Blackberry OS, or the like.

In some non-limiting embodiments or aspects, the computer system (900) may implement a web browser (not shown) stored program component. The web browser may be a hypertext viewing application, such as Microsoft Internet Explorer®, Google Chrome®, Mozilla Firefox®, Apple Safari®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, Adobe Flash, JavaScript, Java, Application Programming Interfaces (APIs), etc. In some non-limiting embodiments or aspects, the computer system (900) may implement a mail server stored program component. In some non-limiting embodiments or aspects, the web server (908) may act as a mail server as well. The mail server may be an Internet mail server such as Microsoft® Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some non-limiting embodiments or aspects, the computer system (900) may implement a mail client stored program component. The mail client may be a mail viewing application, such as Apple Mail, Microsoft Entourage, Microsoft Outlook, Mozilla Thunderbird, etc.

In some non-limiting embodiments or aspects, the computer system (900) is a directory server providing services for facilitating transactions between a merchant associated with an acquirer system and an issuer system. In some non-limiting embodiments or aspects, the computer system (900) is connected to the entities comprising the merchant, acquirer system, and issuer system. In some non-limiting embodiments or aspects, the entities may be several systems connected to the computer system (900) in facilitating the inter wallet transaction.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The described operations may be implemented as a method, system, or article of manufacture using standard programming and/or engineering techniques to produce software, firmware, hardware, or any combination thereof. The described operations may be implemented as code maintained in a “non-transitory computer-readable medium”, where a processor may read and execute the code from the computer-readable medium. The processor is at least one of a microprocessor and a processor capable of processing and executing the queries. A non-transitory computer-readable medium may include media, such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, and the like), and the like. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), and the like).

An “article of manufacture” includes non-transitory computer-readable medium and/or hardware logic in which code may be implemented. A device in which the code implementing the described embodiments of operations are encoded may include a computer-readable medium or hardware logic. Of course, those skilled in the art will recognize that many modifications may be made to this configuration without departing from the scope of the disclosure and that the article of manufacture may include suitable information bearing medium known in the art.

The terms “some non-limiting embodiments or aspects”, “embodiment”, “embodiments”, “the embodiment”, “the embodiments”, “one or more embodiments”, “some-non-limiting embodiments or aspects”, and “some non-limiting embodiments or aspects” mean “one or more (but not all) embodiments of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

The terms “including”, “comprising”, “having”, and variations thereof mean “including but not limited to” unless expressly specified otherwise. The enumerated listing of items does not imply that any or all of the items are mutually exclusive unless expressly specified otherwise. The terms “a”, “an”, and “the” mean “one or more” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

The illustrated operations of FIGS. 5 and 6 show certain events occurring in a certain order. In alternative embodiments or aspects, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

What is claimed is:

1. A computer-implemented method, comprising:
receiving a request from a first user associated with a first wallet server for transferring an amount from the first wallet server to a second wallet server, wherein a second user is associated with the second wallet server, wherein the first wallet server and the second wallet server correspond to a first wallet and a second wallet among a plurality of wallets registered with an inter-wallet transfer system, wherein the request comprises first wallet server information, second wallet server information, and transaction information;
receiving the amount in an intermediate account from the first user via the first wallet server, wherein the intermediate account was created in the inter-wallet transfer system during a registration of the first user with the inter-wallet transfer system and the intermediate account is associated with the first user; and
sending the amount from the intermediate account to the second wallet server in response to the request, for completing a transaction between the first user associated with the first wallet server to the second user associated with the second wallet server.

2. The computer-implemented method of claim 1, wherein the first wallet server information comprises at least a first wallet server name, a first wallet server identity (ID), a first currency supported by the first wallet server, and a first account associated with the first wallet server.

3. The computer-implemented method of claim 2, further comprising:
determining a currency exchange rate between the first currency and a second currency;
receiving the amount in the intermediate account in the first currency; and
sending the amount in the second currency to the second wallet server based on the currency exchange rate between the first currency and the second currency.

4. The computer-implemented method of claim 1, wherein the second wallet server information comprises at least one of the following: a second wallet server name, a second wallet server ID, a second currency supported by the second wallet server, a second account associated with the second wallet server, or any combination thereof.

5. The computer-implemented method of claim 4, further comprising:
determining a currency exchange rate between a first currency and the second currency;
receiving the amount in the intermediate account in the first currency; and
sending the amount in the second currency to the second wallet server based on the currency exchange rate between the first currency and the second currency.

6. The computer-implemented method of claim 4, wherein the second account is associated with at least one of a merchant and an individual user.

7. The computer-implemented method of claim 1, wherein the transaction information comprises at least one of the following: the amount, a currency of transaction using the first wallet server, a currency supported by the second wallet server, a timestamp, a transaction ID, or any combination thereof.

8. The computer-implemented method of claim 1, wherein the request is received before or after scanning a unique code associated with the second wallet server.

9. The computer-implemented method of claim 8, wherein the unique code is at least one of the following: a name tag, bar code, a Quick Response (QR) code, a Near Field Communication (NFC) tag, or any combination thereof.

10. The computer-implemented method of claim 1, wherein the amount is transferred from the first wallet server to the intermediate account, and from the intermediate account to the second wallet server according to ISO 8583 standard and ISO 20022 standard.

11. The computer-implemented method of claim 1, further comprising:
determining a currency exchange rate between a first currency and a second currency;
receiving the amount in the intermediate account in the first currency; and
sending the amount in the second currency to the second wallet server based on the currency exchange rate between the first currency and the second currency.

12. The computer-implemented method of claim 1, wherein the inter-wallet transfer system hosts an application, wherein the application performs one or more of the computer-implemented method steps.

13. A computer-implemented method, comprising:
receiving a plurality of registration details related to a plurality of wallets for registering with an inter-wallet transfer system;
authenticating the plurality of registration details of the plurality of wallets based on a first set of parameters;
creating an identity (ID) for each wallet after authenticating; and
tokenizing the plurality of registration details, for storing the plurality of registration details and a plurality of tokens corresponding to the plurality of registration details in a first database associated with the inter-wallet transfer system.

14. The computer-implemented method of claim 13, wherein the plurality of registration details comprises at least one of the following: a name of the plurality of wallets, an address of the plurality of wallets, currency enabled in the plurality of wallets, or any combination thereof.

15. The computer-implemented method of claim 13, wherein the first set of parameters comprises at least one of the following: a risk score associated with the plurality of wallets, transaction patterns associated with the plurality of wallets, a transaction success rate associated with the plurality of wallets, or any combination thereof.

16. A computer-implemented method, comprising:
receiving a plurality of registration details related to a first user associated with a first wallet server associated with a first wallet among a plurality of wallets, for registering the first user with an inter-wallet transfer system, wherein the plurality of wallets were registered with the inter-wallet transfer system;
authenticating the plurality of registration details related to the first user based on a second set of parameters;
creating an identity (ID) for the first user after authenticating;
tokenizing the plurality of registration details for storing the plurality of registration details and a plurality of tokens corresponding to the plurality of registration details in a second database associated with the inter-wallet transfer system; and
creating an intermediate account in the inter-wallet transfer system, associated with the first user, wherein the inter-wallet transfer system initiates a transaction between a first wallet server and a second wallet server associated with a second wallet from the plurality of wallets, wherein a second user is associated with the second wallet server, wherein the first user generates a request in the inter-wallet transfer system for transferring an amount from the first wallet server to the second wallet server, wherein the request comprises first wallet server information, second wallet server information, and transaction information, wherein the inter-wallet transfer system receives the amount in the intermediate account from the first user via the first wallet server, wherein the inter-wallet transfer system sends the amount to the second wallet server from the intermediate account, in response to the request, for completing a transaction between the first user associated with the first wallet server to the second user associated with the second wallet server.

17. The computer-implemented method of claim 16, wherein the plurality of registration details comprises at least one of the following: a name of the first user, an address of the first user, a preferred currency for transactions, Know Your Customer (KYC) details, or any combination thereof.

18. The computer-implemented method of claim 16, wherein the second set of parameters comprises at least one of the following: a risk score associated with first user, transaction patterns associated with the first user, or any combination thereof.
